(19) United States
(12) Patent Application Publication
(10) Pub. No.: US 2022/0343312 A1
(43) Pub. Date: Oct. 27, 2022

(54) APP PUSH METHOD AND SYSTEM FOR COLLECTING OFFLINE PAYMENT DETAILS

(71) Applicant: Spinor Media Inc., Seoul (KR)

(72) Inventor: Zae Young KIM, Seoul (KR)

(73) Assignee: Spinor Media Inc., Seoul (KR)

(21) Appl. No.: 17/336,458

(22) Filed: Jun. 2, 2021

(30) Foreign Application Priority Data
Apr. 22, 2021 (KR) 10-2021-0052437

(51) Int. Cl. G06Q 20/32; G06Q 20/34; G06Q 20/12

(52) U.S. Cl. CPC G06Q 20/3267; G06Q 20/353; G06Q 20/12

(57) ABSTRACT

Provided is an app push system for collecting offline payment details. The app push system includes a payment company server configured to receive offline payment information of a user from a payment terminal and perform payment processing, an app server configured to receive payment card identification information and seller information from the payment company server, and a user terminal configured to receive an app push message from the app server.

### CROSS REFERENCE TO RELATED APPLICATIONS

This application claims priority to Korean Patent Application No. 10-2020-0052437 filed on Apr. 22, 2021, the entire contents of which are herein incorporated by reference.

### TECHNICAL FIELD

The present disclosure relates to an app push method and system for collecting offline payment details, and particularly to, an app push method and system for collecting big data by requesting payment details of offline payment details from a user terminal using an app server.

### BACKGROUND ART

When a buyer performs card payment at an offline store or an affiliate store, payment/approval is requested through a server of a payment agency such as a value added network (VAN) company, and servers of a card company and a financial company, and when payment/approval is processed, results of payment/approval may be delivered to the buyer and a seller.

Here, the VAN company provides a communication network for an offline card payment, and is a business operator in which when a card is used in online and offline stores, a VAN that connects communication between a card company and a store operates, and establishes a network between a financial institution such as the card company and an affiliate store to relay approval according to use of a card and do business such as purchase of slips on behalf of the financial institution.

In general, payment is made through a Credit Authorization Terminal (CAT) terminal or a Point of Sale (POS) terminal when payment is made at an offline store or affiliated store. In the case of the CAT terminal among payment terminals, only amount information is input without inputting a payment menu, and is transmitted to a payment company server such as a server of the VAN company. Accordingly, a server of a payment company may know only information of the affiliate store and price information. Meanwhile, among payment terminals, the POS terminal is used in an affiliate store of a certain size, and may input not only the price information but also menu information, but does not provide a connecting function of transmitting the menu information between the payment terminal and the VAN company or card companies due to a structure of a connecting system or the affiliate store does not provide the menu information to the VAN company or card company as a policy. Due to such environmental reasons, it is impossible to grasp or collect payment details other than parties in charge of offline stores.

In addition, in order to provide welfare benefits of the government or local governments, a support fund may be provided in conjunction with prepaid cards, credit cards, or check cards held by beneficiaries. In this case, it is impossible to identify which items are specifically purchased by using the support fund when paying by card offline.

Accordingly, there is a need for a new method and system capable of identifying and collecting payment details such as product information or menu information purchased when paying by card offline.

### PRIOR ART DOCUMENT

[Patent Literature 1]
Korean Patent No. 10-1936845

### SUMMARY

### Technical Problem

The present disclosure is directed to providing an app push method and system for requesting and collecting payment details of offline payment details from a user terminal using an app server.

The present disclosure is also directed to providing an app push method and system capable of obtaining detailed information necessary for analysis of big data by requesting and collecting payment details such as product information or menu information purchased by a user when paying by card in an offline store.

The present disclosure is also directed to providing a method and system for more conveniently collecting payment details by providing a product or menu list while selecting a target who needs to obtain payment details and requesting input of payment details through an app push.

The present disclosure is also directed to providing a system that enables the government or local governments to obtain payment details payed by a support target offline when providing welfare benefits to a socially vulnerable class and a welfare support target of the government or local governments, thereby maximizing the effect of welfare benefits and enabling active administrative services.

The present disclosure is also directed to providing a system that enables collection of payment details information of offline payment by utilizing a network between a conventional payment company server (a VAN company, a card company, a financial company server, etc.)

The problems to be solved of the present disclosure are not limited to the description mentioned above, and other technical problems that are not mentioned will be clearly understood by those skilled in the art from the following description.

### Technical Solution

In one aspect of the present disclosure, there is provided an app push system for collecting offline payment details including a payment company server configured to receive offline payment information of a user from a payment terminal and perform payment processing; an app server configured to receive payment card identification information and seller information from the payment company server; and a user terminal configured to receive an app push message from the app server.

The payment company server may include at least one of a VAN company server, a card company server, and a financial company server.

The app server may be configured to identify the user based on the payment card identification information received from the payment company server, and determine whether the user is a target of receiving the app push message.

The app push message may include a request for inputting payment details related to the offline payment information.

The payment details may be related to product information or menu information purchased by the user.

The app server may be configured to collect payment details input by a plurality of users.

The app server may be configured to provide a reward benefit to a user who inputs the payment details in response to the app push message.

The app server may be configured to generate a list of the product information or the menu information based on the seller information, and the request for inputting the payment details may select a product or a menu purchased from the list of the product information or the menu information.

In another aspect of the present disclosure, there is provided an app push method for collecting offline payment details including receiving, by a payment company server, offline payment information of a user from a payment terminal and performing, by the payment company server, payment processing; receiving, by an app server, payment card identification information and seller information from the payment company server; and generating, by the app server, an app push message and transmitting, by the app server, the app push message to a user terminal of the user.

The payment company server may include at least one of a VAN company server, a card company server, and a financial company server.

The app push method may further include identifying, by the app server, the user based on the payment card identification information received from the payment company server; and determining, the app server, whether the user is a target of receiving the app push message.

The app push message may include a request for inputting payment details related to the offline payment information.

The payment details may be related to product information or menu information purchased by the user.

The app server may be configured to collect payment details input by a plurality of users.

The app push method may further include providing, by the app server, a reward benefit to a user who inputs the payment details in response to the app push message.

The app push method may further include generating, by the app server, a list of the product information or the menu information based on the seller information, wherein the request for inputting the payment details is configured to select a product or a menu purchased from the list of the product information or the menu information.

### Advantageous Effects

The present disclosure may provide an app push method and system for requesting and collecting payment details of offline payment details from a user terminal using an app server.

The present disclosure may also provide an app push method and system capable of obtaining detailed information necessary for analysis of big data by requesting and collecting payment details such as product information or menu information purchased by a user when paying by card in an offline store.

The present disclosure may also provide a method and system for more conveniently collecting payment details by providing a product or menu list while selecting a target who needs to obtain payment details and requesting input of payment details through an app push.

The present disclosure may also provide a system that enables the government or local governments to obtain payment details payed by a support target offline when providing welfare benefits to a socially vulnerable class and a welfare support target of the government or local governments, thereby maximizing the effect of welfare benefits and enabling active administrative services.

The present disclosure may also provide a system that enables collection of payment details information of offline payment by utilizing a network between a conventional payment server (a VAN company, a card company, a financial company server, etc.)

The effects of the present disclosure are not limited to the description mentioned above, and other effects not mentioned will be clearly understood by those skilled in the art from the following description.

### BRIEF DESCRIPTION OF DRAWINGS

FIG. 1 is a conceptual diagram of a system for providing an app push method for collecting offline payment details according to an embodiment of the present disclosure.

FIG. 2 is an example view illustrating an input request screen of payment details through an app push message according to an embodiment of the present disclosure.

FIG. 3 is a flowchart illustrating an app push method for collecting offline payment details according to an embodiment of the present disclosure.

### DETAILED DESCRIPTION OF DRAWINGS

The terms used herein are for the purpose of describing embodiments and are not intended to limit the present disclosure. As used herein, the singular forms also are intended to include the plural forms as well, unless the context clearly indicates otherwise.

It will be further understood that the terms “comprises” and/or “comprising,” when used in this specification, specify the presence of stated elements, steps, operations, and/or components, but do not preclude the presence or addition of one or more other elements, steps, operations, and/or components.

In addition, the terms including ordinals such as “first”, “second”, etc. may be used to describe various components, but the components are not limited to these terms. The terms are used only for the purpose of distinguishing one component from another. In addition, in describing the present disclosure, when it is determined that a detailed description of a related known technology may obscure the spirit of the present disclosure, a detailed description thereof will be omitted.

In addition, configuration units shown in the embodiments of the present disclosure are independently illustrated to represent different characteristic functions, and does not mean that each configuration unit includes separate hardware or a single software configuration unit. That is, each configuration unit is listed and described as a respective configuration unit for convenience of description, and at least two configuration units of each configuration unit are combined to form a single configuration unit, or one configuration unit may be divided into a plurality of configuration units to perform a function. Integrated embodiments and separate embodiments of each of the configuration units are also included in the scope of the present disclosure unless departing from the spirit of the present disclosure.

Hereinafter, embodiments of the present disclosure will be described in detail with reference to the accompanying drawings. The configuration of the present disclosure and its effect will be clearly understood through the detailed description below.

FIG. 1 is a conceptual diagram of a system for providing an app push method for collecting offline payment details according to an embodiment of the present disclosure.

Referring to FIG. 1, a payment terminal 100 is a terminal used for payment in an offline store or an affiliate store, and may be a device capable of various types of payments, such as a CAT terminal or a POS terminal.

When offline card payment is made in the payment terminal 100, basic payment information including card information, s payment amount, and information of the affiliate store is transmitted to a payment company server 200. Here, the basic payment information does not include payment details such as specific product information or menu information for which payment has been made. As such, a payment processing process is performed in conjunction with a payment gateway server such as a VAN company or a payment server of a credit card company and a financial company during offline payment. The servers operated by payment related companies will be collectively referred to as the payment company server 200.

When a payment approval is made in the payment company server 200, card identification information and the basic payment information may be transmitted to an app server 300 configured to operate an app for collecting payment details. The payment company and the app operator may establish a connecting system to provide payment information obtained through the payment company server 200 to the app server 300 according to a mutual agreement. The app server 300 may obtain user information corresponding to a corresponding card based on the received card identification information based on card information and identification (ID) identification information input by a user when registering as a member of an app. In addition, the app server 300 may determine whether the identified user is an app push target who needs to transmit an app push message based on previously obtained user type information. For example, when a specific user is a welfare beneficiary of the government or a local government, or is a target to which a specific advertisement campaign is applied, the app server 300 may previously designate and classify the corresponding users as app push targets.

When the app server 300 determines that the identified user is the app push target, the app server 300 may transmit the app push message requesting an input of payment details to a user terminal 400 of the corresponding user. The user terminal 400 is a computer device configured to allow a user to execute the corresponding app, and may be configured in various forms such as a smart phone, a tablet computer, a desktop computer, a laptop computer, a notebook computer, a workstation, a server computer, a personal digital assistant (PDA), a portable computer, a wireless phone, a mobile phone, a wearable device, smart glasses, a smart TV, an AI speaker, etc.

The user may input payment details related to card payment details through an input unit of the user terminal 400. For example, the payment details may include product information or menu information related to the card payment, or affiliate store evaluation information. For example, the app server 300 may load previously obtained product or menu list information based on the affiliate store information on which card payment has been performed, the user terminal 400 may display a product information list or a menu information list related to the card payment when executing the app, and the user may select a paid item from the list and conveniently input the payment details.

When the payment details are input through the user terminal 400, payment details information is transmitted to the app server 300, and the app server 300 may receive and collect payment details from a plurality of users to obtain big data and analyze the payment details.

In addition, the app server 300 may be configured to provide reward benefits to users who have input the payment details. For example, when the user performs offline card payment at a restaurant, selects a food menu purchased in the restaurant through an app push, and performs star rating of the restaurant, the app server 300 may provide reward benefits such as a discount coupons or a mileage provision through the app. Alternatively, when the user performs offline card payment at a grocery store, selects product information purchased in the store through the app push, and performs star rating of the store, the app server 300 may provide reward benefits such as a discount coupons or a mileage provision through the app. By providing such reward benefits, it is possible to induce the user to voluntarily input the payment details.

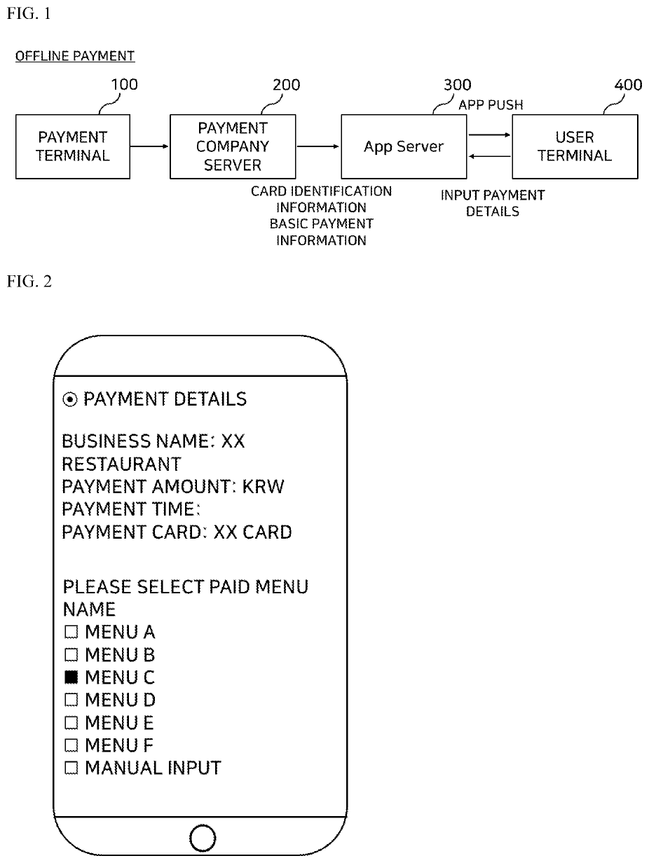

FIG. 2 is an example view illustrating an input request screen of payment details through an app push message according to an embodiment of the present disclosure.

For example, when an app user performs offline payment with a credit card or prepaid card at a restaurant, a notification may be sent to the user terminal 400 through an app push, and a screen for requesting an input of payment details may be provided as shown in FIG. 2. The user confirms basic payment details of an affiliate store where offline payment has been performed, such as a business name, a payment amount, a payment time, payment card information, etc., and selects a menu purchased by the user from a payment details list related to the corresponding payment details displayed on the user terminal 400 to perform the input of the payment details.

When the input of the payment details is performed through the user terminal 400, payment details input information may be transmitted to the app server 300, and the user may receive a reward benefit when a specific condition is satisfied.

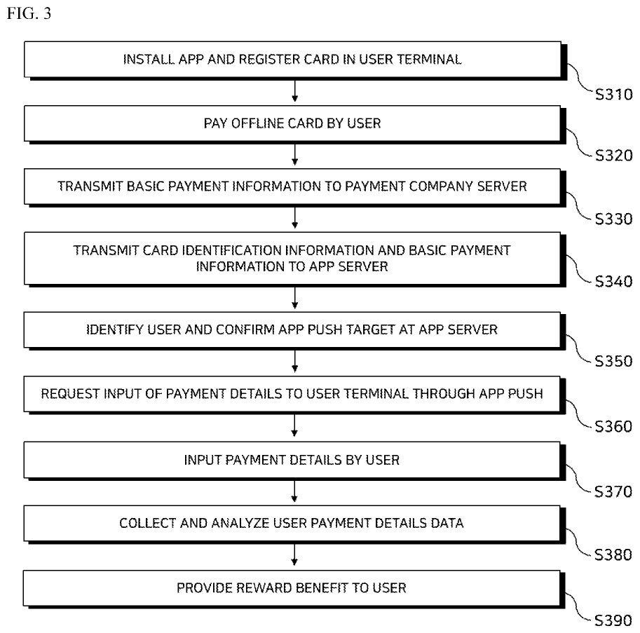

FIG. 3 is a flowchart illustrating an app push method for collecting offline payment details according to an embodiment of the present disclosure.

First, a user may install an app on the user terminal 400 such as a smartphone, and register a card such as a credit card or a prepaid card used by the user (S310). Accordingly, the app server 300 may associate app ID information of the user with credit card or prepaid card information held by the user.

When the user performs offline card payment using the credit card or the prepaid card (S320), basic payment information such as card information, affiliate store information, and payment information is transmitted to the payment company server 200 such as a VAN company (S330).

The payment company server 200 such as the VAN company may transmit card identification information and the basic payment information to the app server 300 (S340).

The app server 300 may perform user identification based on the received card identification information, and confirm whether the corresponding user is an app push target (S350).

When the corresponding user is the app push target, the app server 300 may request an input of payment details to the user terminal 400 through an app push (S360).

The user may input the payment details such as a purchased product item or menu information, and affiliate store evaluation information through the user terminal 400 (S370).

The app server 300 may collect user payment details data through the user's input of the detailed payment details (S380). The app server 300 may perform analysis of big data by collecting payment details data of a plurality of users.

The app server 300 may also provide reward benefits such as a discount coupon provision or mileage provision to the user who has input the payment details (S390).

In the above, an app push method and system for collecting offline payment details according to the embodiments of the present disclosure have been described as specific various embodiments, but this is only an example, and the present disclosure is not limited thereto, and should be construed as having the widest scope according to the basic idea disclosed herein. Those skilled in the art may combine and replace the disclosed embodiments to implement a pattern having a shape that is not indicated, but this also does not depart from the scope of the present disclosure. In addition, those skilled in the art may easily change or modify the disclosed embodiments based on the present specification, and it is clear that such changes or modifications also belong to the scope of the present disclosure.

1. An app push system for collecting offline payment details, the app push system comprising:
a payment company server configured to receive offline payment information of a user from a payment terminal and perform payment processing;
an app server configured to:
receive payment card identification information and seller information from the payment company server after the payment company server approves the payment of the user;
identify the user based on the payment card identification information received from the payment company server, and determine whether the user is a target of receiving an app push message based on a comparison of the identified user and predetermined targets; and
transmit the app push message to a user terminal in response to determining that the user is the target of receiving the app push message, wherein the app push message comprises a request for inputting payment details including product information or menu information related to the offline payment information; and
the user terminal configured to:
receive the app push message from the app server;
receive the payment details including the product information or the menu information related to the offline payment information from the user in response to displaying the request for inputting the payment details; and
transmit the received product information or menu information to the app server,
wherein the payment company server comprises at least one of a VAN company server, a card company server, and a financial company server.

2.-5. (canceled)

6. The app push system of claim 1, wherein the app server is configured to collect payment details input by a plurality of users.

7. The app push system of claim 1, wherein the app server is configured to provide a reward benefit to a user who inputs the payment details in response to the app push message.

8. The app push system of claim 1, wherein the app server is configured to generate a list of the product information or the menu information based on the seller information, and the request for inputting the payment details is configured to select a product or a menu purchased from the list of the product information or the menu information.

9. An app push method for collecting offline payment details, the app push method comprising:
receiving, by a payment company server, offline payment information of a user from a payment terminal and performing, by the payment company server, payment processing;
receiving, by an app server, payment card identification information and seller information from the payment company server after the payment company server approves the payment of the user;
identifying, by the app server, the user based on the payment card identification information received from the payment company server, and determining whether the user is a target of receiving an app push message based on a comparison of the identified user and predetermined targets;
transmitting, by the app server, the app push message to a user terminal in response to determining that the user is the target of receiving the app push message, wherein the app push message comprises a request for inputting payment details including product information or menu information related to the offline payment information;
generating, by the app server, an app push message and transmitting, by the app server, the app push message to a user terminal of the user;
receiving, by the user terminal, the app push message from the app server;
receiving, by the user terminal, the payment details including the product information or the menu information related to the offline payment information from the user in response to displaying the request for inputting the payment details; and
transmitting, by the user terminal, the received product information or menu information to the app server,
wherein the payment company server comprises at least one of a VAN company server, a card company server, and a financial company server.

10.-13. (canceled)

14. The app push method of claim 9, wherein the app server is configured to collect payment details input by a plurality of users.

15. The app push method of claim 9, further comprising providing, by the app server, a reward benefit to a user who inputs the payment details in response to the app push message.

16. The app push method of claim 9, further comprising generating, by the app server, a list of the product information or the menu information based on the seller information, wherein the request for inputting the payment details is configured to select a product or a menu purchased from the list of the product information or the menu information.

17. The app push system of claim 1, wherein the predetermined targets includes a welfare beneficiary of a government or a target to which a predetermined advertisement campaign is applied.

18. The app push method of claim 9, wherein the predetermined targets includes a welfare beneficiary of a government or a target to which a predetermined advertisement campaign is applied.
